(19) United States
(12) Patent Application Publication
(10) Pub. No.: US 2015/0066282 A1
(43) Pub. Date: Mar. 5, 2015

(54) AUTONOMOUS DRIVING IN AREAS FOR NON-DRIVERS

(71) Applicant: Ford Global Technologies, LLC, Dearborn, MI (US)

(72) Inventor: Wilford Trent Yopp, Canton, MI (US)

(73) Assignee: Ford Global Technologeis, LLC, Dearborn, MI (US)

(21) Appl. No.: 14/018,559

(22) Filed: Sep. 5, 2013

(51) Int. Cl. G05D 1/00

(52) U.S. Cl. CPC G05D 1/0088
USPC 701/24

(57) ABSTRACT

A message is received from a vehicle via a network. A driver status is identified based on at least one of whether the message was received and content in the message. A driving instruction is determined based at least in part on the driver status. The driving instruction is transmitted via the network.

### BACKGROUND

A vehicle such as an automobile may be configured for autonomous driving operations. For example, the vehicle may include a central control unit or the like, i.e., the computing device having a processor and a memory, that receives data from various vehicle data collection devices such as sensors. The central control unit may then provide instructions to various vehicle components, e.g., actuators and the like that control steering, braking, acceleration, etc., to control vehicle operations without action by a human operator. Therefore, it is possible for an autonomous vehicle to operate irrespective of a state or condition of a human operator. Accordingly, there is a need for autonomous vehicles to take into account a human driver's state or condition in executing vehicle operations.

### DRAWINGS

FIG. 1 is a block diagram of an exemplary autonomous vehicle system.

FIG. 2 is a diagram of an exemplary process for an autonomous vehicle to send and/or receive messages related to a driver and/or vehicle condition.

FIG. 3 is a diagram of an exemplary process for an autonomous vehicle management infrastructure receive and/or send messages related to operation of one or more driverless vehicles.

### DETAILED DESCRIPTION

### System Overview

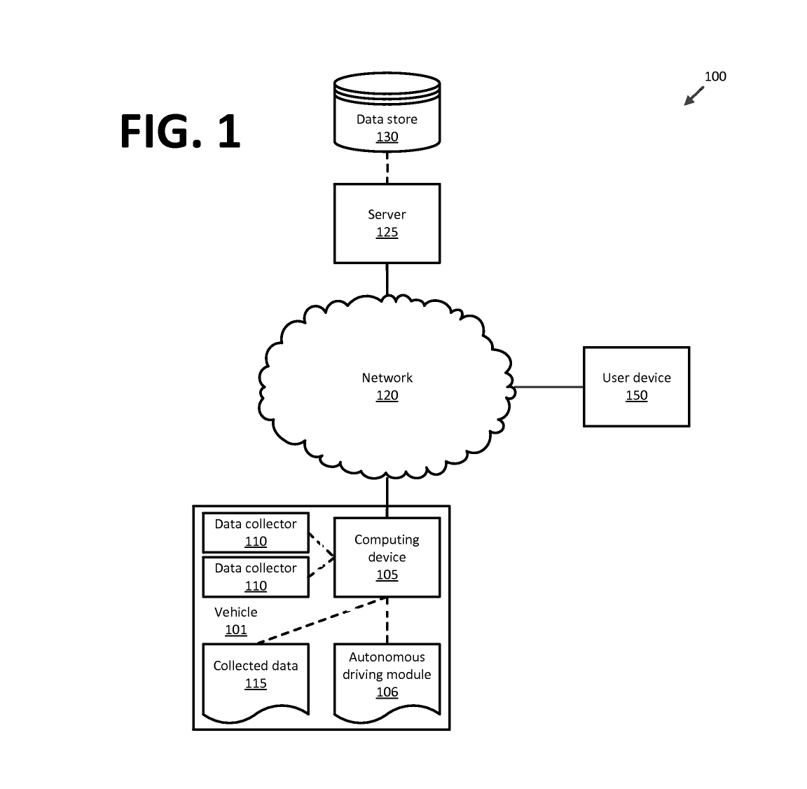

FIG. 1 is a block diagram of an exemplary autonomous vehicle system 100. A vehicle 101 includes a vehicle computer 105 that is configured to receive information, e.g., collected data 115, from one or more data collectors 110 concerning various metrics related to a vehicle operator and/or the vehicle 101. For example, such metrics may include a speed (i.e., velocity) of the vehicle 101, vehicle acceleration and/or deceleration, data related to a vehicle path or steering, biometric data related to a vehicle operator, e.g., heart rate, respiration, pupil dilation, body temperature, state of consciousness, etc. Further examples of such metrics may include the functionality of the vehicle 101 systems and components (e.g., steering system, powertrain system, brake system, internal sensing, external sensing, etc.). The computer 105 generally includes an autonomous driving module 106 that comprises instructions for autonomously, i.e., without operator input, operating the vehicle 101, including in response to instructions received from a server 125. The computer 105 may also include instructions for determining a state of a vehicle 101 operator and/or the vehicle 101. The computer 105 may further be configured for communicating with one or more remote sites such as the server 125, via a network 120, such remote site possibly including a data store 130. The server 125 may be configured to determine an appropriate action for one or more vehicles 101, and to provide direction to the computer 105 to proceed accordingly.

### Exemplary System Elements

A vehicle 101 includes a vehicle computer 105 that generally includes a processor and a memory, the memory including one or more forms of computer-readable media, and storing instructions executable by the processor for performing various operations, including as disclosed herein. Further, the computer 105 may include more than one computing device, e.g., controllers or the like included in the vehicle 101 for monitoring and/or controlling various vehicle components, e.g., an engine control unit (ECU), transmission control unit (TCU), etc. The computer 105 is generally configured for communications on a controller area network (CAN) bus or the like. The computer 105 may also have a connection to an onboard diagnostics connector (OBD-II). Via the CAN bus, OBD-II, and/or other wired or wireless mechanisms, the computer 105 may transmit messages to various devices in a vehicle and/or receive messages from the various devices, e.g., controllers, actuators, sensors, etc., including data collectors 110. Alternatively or additionally, in cases where the computer 105 actually comprises multiple devices, the CAN bus or the like may be used for communications between devices represented as the computer 105 in this disclosure. In addition, the computer 105 may be configured for communicating with the network 120, which, as described below, may include various wired and/or wireless networking technologies, e.g., cellular, Bluetooth, wired and/or wireless packet networks, etc.

Generally included in instructions stored in and executed by the computer 105 is an autonomous driving module 106. Using data received in the computer 105, e.g., from data collectors 110, the server 125, etc., the module 106 may control various vehicle 101 components and/or operations without a driver to operate the vehicle 101. For example, the module 106 may be used to regulate vehicle 101 speed, acceleration, deceleration, steering, operation of components such as lights, windshield wipers, etc.

Data collectors 110 may include a variety of devices. For example, various controllers in a vehicle may operate as data collectors 110 to provide data 115 via the CAN bus, e.g., data 115 relating to vehicle speed, acceleration, system and/or component functionality, etc. Further, sensors or the like, global positioning system (GPS) equipment, etc., could be included in a vehicle and configured as data collectors 110 to provide data directly to the computer 105, e.g., via a wired or wireless connection. Sensor data collectors 110 could include mechanisms such as RADAR, LADAR, sonar, etc. sensors that could be deployed to measure a distance between the vehicle 101 and other vehicles or objects. Yet other sensor data collectors 110 could include cameras, breathalyzers, motion detectors, etc., i.e., data collectors 110 to provide data for evaluating a condition or state of a vehicle 101 operator.

A memory of the computer 105 generally stores collected data 115. Collected data 115 may include a variety of data collected in a vehicle 101. Examples of collected data 115 are provided above, and moreover, data 115 is generally collected using one or more data collectors 110, and may additionally include data calculated therefrom in the computer 105, and/or at the server 125. In general, collected data 115 may include any data that may be gathered by a collection device 110 and/or computed from such data.

The network 120 represents one or more mechanisms by which a vehicle computer 105 may communicate with a remote server 125. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 125 may be one or more computer servers, each generally including at least one processor and at least one memory, the memory storing instructions executable by the processor, including instructions for carrying out various steps and processes described herein. The server 125 may include or be communicatively coupled to a data store 130 for storing collected data 115, records relating to potential incidents generated as described herein, etc. Further, the server 125 may store information related to particular vehicle 101 and additionally one or more other vehicles 101 operating in a geographic area, traffic conditions, weather conditions, etc., within a geographic area, with respect to a particular road, city, etc. The server 125 could be configured to provide drive-by-wire instructions to a particular vehicle 101 and/or other vehicles 101 in an autonomous driving area, e.g., a road, etc., such as an “all stop” instruction for all vehicles 101 in an area, or for a specific vehicle 101 to stop, a speed restriction, a lane restriction, etc.

A user device 150 may be any one of a variety of computing devices including a processor and a memory, as well as communication capabilities. For example, the user device 150 may be a portable computer, tablet computer, a smart phone, etc. that includes capabilities for wireless communications using IEEE 802.11, Bluetooth, and/or cellular communications protocols. Further, the user device 155 may use such communications capabilities to communicate via the network 120 and also directly with a vehicle computer 105, e.g., using Bluetooth.

### Exemplary Process Flows

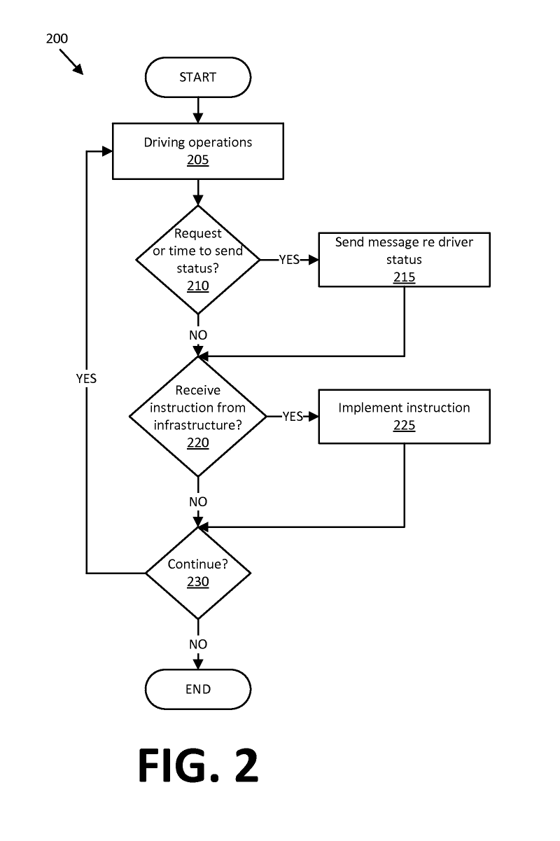

FIG. 2 is a diagram of an exemplary process 200 for an autonomous vehicle to send and/or receive messages related to a driver and/or vehicle condition.

The process 200 begins in a block 205, in which a vehicle 101 conducts driving operations. In general, driving operations could be conducted according to manual input by a vehicle 101 operator, e.g., by input via a steering wheel, a brake, and accelerator, etc. Additionally or alternatively, as mentioned above, the computer 105 could be configured to control operation of the vehicle 101 based on collected data 115 and/or instructions from the server 125. That is, the vehicle 101 could be driven completely autonomously according to instructions to various vehicle 101 components by the computer 105, and/or the vehicle 101 could be driven partially autonomously, e.g., according to instructions to various vehicle components by the computer 105 in combination with driver inputs to one or more vehicle components, e.g., steering, braking, etc.

Next, in a block 210, the computer 105 determines whether to send a message concerning vehicle 101 status and/or vehicle 101 operator status to the server 125 and/or other vehicles 101. In general, when driving operations are commenced, i.e., in a first iteration of the block 210, the computer 105, e.g., according to instructions in the module 106, could be configured to send a message to the server 125 identifying the vehicle 101, e.g., according to a unique or substantially unique identifier. Such message could also include a location of the vehicle 101, and other information, such as whether the vehicle 101 is being driven manually, autonomously, or in some combination of manual and autonomous operations and/or the functionality of its systems. A message from the vehicle 101 to the server 125 could also include information about a vehicle 101 operator, including whether an operator is present, and identifying information from which the server 125 could determine whether the vehicle 101 operator was competent to operate the vehicle 101, e.g., whether the operator was licensed, of sufficient age and experience for driving conditions, whether the operator was impaired in any way, etc. A message from the vehicle 101 to the server 125 could also include information about sensing systems on vehicle 101 and their respective capabilities and limitations. Further, a message could include the capabilities of components such as steering, powertrain and braking systems.

Further, concerning a second and subsequent iterations of the process 200, the computer 105 may be configured to periodically evaluate vehicle 101 and/or operator status, and to provide a message concerning the same to the server 125. Alternatively or additionally, the computer 105 could be configured to receive a request from the server 125 for such status(es). The server 125, in turn, could be configured to periodically request status information from a particular vehicle 101 and one or more other vehicles 101 for which the server 125 serves as, or as part of, an autonomous driving infrastructure.

Yet further, the computer 105 could determine to send a message concerning vehicle 101 and/or operator status according to a determination of such status. For example, if the computer 105 determined that an operator was not present, e.g., no one was sitting in a driver's seat, or that a driver had suffered some sudden impairment, e.g., fallen asleep or lost consciousness, the computer 105, e.g., according to instructions in the module 106, could determine to send a message to the server 125.

In any event, if the computer 105 determines to send a message concerning vehicle 101 and/or operator status, such status may be determined according to a variety of mechanisms. For example, as just mentioned, the computer 105 could be configured to periodically evaluate vehicle 101 and/or operator status, and to send a message to the server 125 concerning the same when warranted by the status. Additionally or alternatively, the computer 105 could determine, e.g., according to a periodic schedule as mentioned above, that a status message to the server 125 is due, and accordingly could determine and transmit to the server 125 information concerning vehicle 101 and/or operator status.

A block 215 is executed if the computer 105 determines in the block 210 to send a message concerning vehicle 101 and/or operator status. If the computer 105 determines not to send a such a message, then a block 220 is executed next.

In the block 215, the computer 105 sends a message concerning vehicle 101 and/or operator status to the server 125. For example, such message may be sent in one or more Internet protocol (IP) packets via the network 120. Fields in the message could include a unique or substantially unique identifier for the vehicle 101, one or more status codes, descriptions, etc., and/or other information relating to the vehicle 101, such as geo-coordinates concerning a vehicle 101 location, information concerning vehicle 101 operating parameters, including, just to name a few examples, a vehicle speed, direction, fuel level, tire pressure, system and component functionality, etc.

In the block 220, which may follow the block 210 or the block 215, as described above, the computer 105, e.g., according to instructions in the module 106, determines whether a message has been received from the server 125. For example, the server 125 may send a message, e.g., in one or more IP packets via the network 120, that includes an instruction concerning vehicle 101 operation based on a status message sent as described above concerning the block's 210 in 215, and/or according to an evaluation by the server 125 of statuses of one or more other vehicles 101 and/or conditions in a driving area, e.g., a region defined by geographic coordinates, that is controlled and/or monitored by the server 125. An instruction concerning vehicle 101 operation included in a message from the server 125 could include an instruction for a vehicle 101 to stop, to not exceed a certain speed, to avoid a certain geographic area, a certain road, etc. Further, the server 125 could send an instruction to more than one vehicle, e.g., a “global stop” message to all vehicles in a particular geographic area due to an unsafe condition such as an unresponsive vehicle or a vehicle that has a determined defect/limitation that is likely to cause harm to itself and/or other vehicles in the geographic area.

A block 225 is executed following the block 220 if a message has been received from the server 125. Otherwise, a block 230 is executed following the block 220.

In the block 225, the computer 105, e.g., according to instructions in the module 106, implements an instruction or instructions received from the server 125. For example, the module 106 may execute instructions to various vehicle 101 components to effect a stop of the vehicle 101.

In the block 230, the computer 105 determines whether the process 200 should continue. For example, the process 200 generally stops when vehicle 101 operation stops, e.g., when a vehicle 101 reaches its desired location or the engine is powered off. Likewise, a vehicle 101 could leave a geographic area controlled and/or monitored by a server 125, whereupon continuation of the process 200 is not possible. In any event, if the process 200 is to be continued, control returns to the block 205. Otherwise, the process 200 ends.

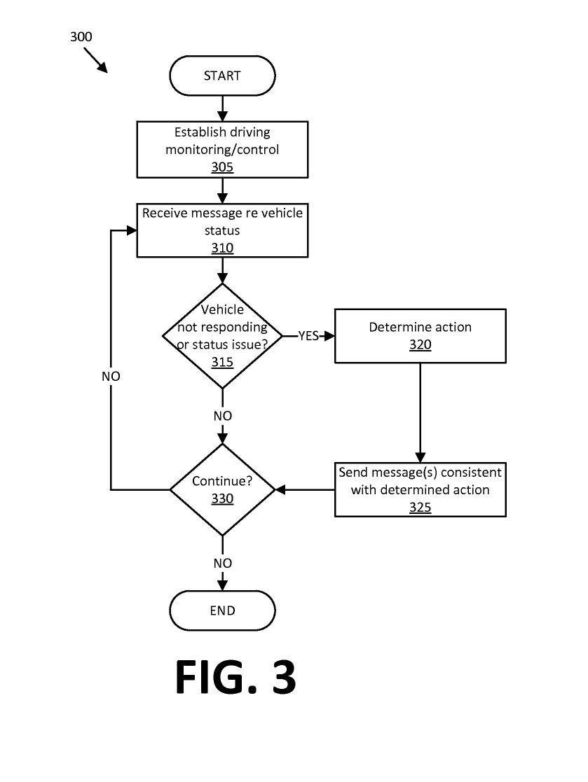

FIG. 3 is a diagram of an exemplary process 300 for an autonomous vehicle management infrastructure, e.g., the server 125, to receive and/or send messages related to operation of one or more driverless vehicles.

The process 300 begins in a block 305, in which the server 125 establishes monitoring and/or control of one or more vehicles 101. For example, as mentioned above, the server 125, which as disclosed herein may represent an infrastructure for monitoring and/or controlling autonomous or potentially autonomous vehicles such as a vehicle 101, may send and receive messages with one or more vehicles 101 via the network 120.

Next, in a block 310, the server 125 receives at least one message from at least one vehicle 101 concerning a status of the vehicle 101. A message from a vehicle 101 may further include general information concerning an autonomous driving area monitored and/or controlled by the server 125, such as environmental conditions, e.g., outside temperature, presence or absence of precipitation, road conditions, lighting conditions, lane operation restrictions, etc. Further, such environmental information could be conveyed via other mechanisms, e.g., wired and/or wireless sensors in communication with the server 125 via the network 120.

As noted above, the server 125 may receive a message from a vehicle 101 in response to a query, e.g., sent periodically, from the server 125 to the vehicle 101. Alternatively or additionally, a vehicle 101 may periodically send one or more messages to the server 125.

In any event, following the block 310, in a block 315, the server 125 evaluates one or more messages received from vehicles 101 and/or other gathered information such as described above. Further, the server 125 may evaluate an absence of a message from a vehicle 101, e.g., a message is not received when due or in response to a query. Based on information obtained in the block 315, the server 125 determines whether a safety issue or the like is presented by a vehicle 101. For example, a safety issue could be presented if a vehicle 101 does not have a human operator present in a driver's seat and environmental conditions pose dangers that require driver monitoring, if a human operator present in a driver's seat lacks driving experience or a license to deal with present driving conditions, if a human operator is asleep, under the influence of drugs and/or alcohol, unconscious, etc. Similarly, a safety issue could be presented if a vehicle 101 was operating in a semi-autonomous or manual mode in a highway lane that was restricted for fully autonomous driving with very close following distances. In another case, a safety issue could be presented if a brush fire caused thick smoke to cover a roadway and a certain vehicle 101 operating in an autonomous mode had known sensing limitations for this type of environmental condition.

If a safety condition or potential safety issues determined in the block 315, then a block 320 is executed next. Otherwise, a block 330 is executed next.

In the block 320, the server 125 determines an action to be taken with respect to the vehicle 101 presenting the safety issue and/or other vehicles 101 in an autonomous driving area. For example, as mentioned above, the server 125 could determine that a “global stop” is appropriate for all vehicles 101 in a particular geographic driving area, on a particular portion of a road, etc. Similarly, the server 125 could determine that, based on a driver condition, e.g., unconsciousness, a particular vehicle 101 should be stopped until assistance can be provided.

Following the block 320, in a block 325, the server 125 sends a message to one or more vehicles 101 based on a determined course of action for the one or more vehicles 101 as described above concerning the blocks 315 and 320.

The block 330 may follow either the block 315 are the block 325. In the block 330, the server 125 determines whether to continue the process 300, e.g., the server 125 could receive instruction to shut down, could cease receiving messages from vehicles 101 for a period of time, etc. If so, the process 300 ends. Otherwise, the process 300 returns to the block 310.

### CONCLUSION

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising a server computer comprising a processor and a memory, wherein the computer is configured to:
receive a message from a vehicle via a network;
identify a driver status based on at least one of whether the message was received and content in the message;
determine a driving instruction based at least in part on the driver status;
transmit the driving instruction via the network.

2. The system of claim 1, wherein the driving instruction is transmitted to at least one of the vehicle and one or more second vehicles.

3. The system of claim 1, wherein the driving instruction is an instruction to stop driving operations.

4. The system of claim 1, wherein the driving instruction is based on an environmental condition in a geographic area that includes the vehicle in addition to the driver status.

5. The system of claim 1, wherein a computer in the vehicle is configured to send periodically messages to the server computer.

6. The system of claim 1, wherein the driver status is related to one of a state of driver consciousness, and impairment by drugs or alcohol, and a driver license status.

7. The system of claim 1, wherein the computer is further configured to:
receive a second message from one of the vehicle and a second vehicle via a network;
identify a second driver status based on at least one of whether the message was received and content in the message;
determine a second driving instruction based at least in part on the driver status;
transmit the second driving instruction via the network.

8. A non-transitory computer-readable medium tangibly embodying computer-executable instructions, the instructions comprising instructions to:
receive a message from a vehicle via a network;
identify a driver status based on at least one of whether the message was received and content in the message;
determine a driving instruction based at least in part on the driver status;
transmit the driving instruction via the network.

9. The medium of claim 8, wherein the driving instruction is transmitted to at least one of the vehicle and one or more second vehicles.

10. The medium of claim 8, wherein the driving instruction is an instruction to stop driving operations.

11. The medium of claim 8, wherein the driving instruction is based on an environmental condition in a geographic area that includes the vehicle in addition to the driver status.

12. The medium of claim 8, wherein a computer in the vehicle is configured to send periodically messages to the server computer.

13. The medium of claim 8, wherein the driver status is related to one of a state of driver consciousness, and impairment by drugs or alcohol, and a driver license status.

14. The medium of claim 8, the instructions further comprising instructions to:
receive a second message from one of the vehicle and a second vehicle via a network;
identify a second driver status based on at least one of whether the message was received and content in the message;
determine a second driving instruction based at least in part on the driver status;
transmit the second driving instruction via the network.

15. A method, comprising:
receiving a message from a vehicle via a network;
identifying a driver status based on at least one of whether the message was received and content in the message;
determining a driving instruction based at least in part on the driver status;
transmitting the driving instruction via the network.

16. The method of claim 15, wherein the driving instruction is transmitted to at least one of the vehicle and one or more second vehicles.

17. The method of claim 15, wherein the driving instruction is an instruction to stop driving operations.

18. The method of claim 15, wherein the driving instruction is based on an environmental condition in a geographic area that includes the vehicle in addition to the driver status.

19. The method of claim 15, wherein a computer in the vehicle is configured to send periodically messages to the server computer.

20. The method of claim 15, wherein the driver status is related to one of a state of driver consciousness, and impairment by drugs or alcohol, and a driver license status.

21. The method of claim 15, further comprising:
receiving a second message from one of the vehicle and a second vehicle via a network;
identifying a second driver status based on at least one of whether the message was received and content in the message;
determining a second driving instruction based at least in part on the driver status;
transmitting the second driving instruction via the network.
